(19) United States
(12) Patent Application Publication
(10) Pub. No.: US 2026/0132838 A1
(43) Pub. Date: May 14, 2026

(54) Tightening And Adjustment Device

(71) Applicant: Dongguan Fushun Sports Goods Co., Ltd., Dongguan (CN)

(72) Inventor: Xiaogao Gu, Ji'an (CN)

(73) Assignee: Dongguan Fushun Sports Goods Co., Ltd., Dongguan (CN)

(21) Appl. No.: 18/957,674

(22) Filed: Nov. 23, 2024

(30) Foreign Application Priority Data
Nov. 11, 2024 (CN) 2024115998902

(51) Int. Cl. F16G 11/12

(52) U.S. Cl. CPC F16G 11/12

(57) ABSTRACT

Disclosed is a tightening and adjustment device, including: a foundation base, a driving part rotatably connected to the foundation base, and a winding part arranged along a rotation axis of the driving part, where a locking part is arranged between one end of the winding part and the foundation base, a one-way engagement part is arranged between the other end of the winding part and the driving part, and when the driving part rotates, the one-way engagement part drives the winding part to rotate around the axis; and an unlocking part arranged on a side of the one-way engagement part, where when the unlocking part pushes the winding part to move towards the locking part, the winding part is released. Back-and-forth swinging of the shifting plate drives an entire swing base to rotate on the foundation base, and further drives a wire spool to rotate unidirectionally for winding.

### TECHNICAL FIELD

The present disclosure relates to the technical field of daily necessities, and in particular to a tightening and adjustment device.

### BACKGROUND

Rope straps are commonly used for tying up shoes, clothing and protective gear, and bundling products. The purpose of fixing an item can be achieved by adjusting tightness of a rope strap. Currently, a person needs to pull both ends of a rope strap with both hands to adjust its tightness, and then fix the rope strap by knotting with hands. However, it is difficult to ensure the tightness of knotting.

In the prior art, the tightness of a rope strap is adjusted mainly by rotating, and a force conversion rate of rotating and winding the rope strap mainly depends on a diameter of a knob. As a result, a size of the knob is limited, and difficulty in winding or inconvenience to use due to oversize occurs in use. Therefore, a new tightening and adjustment device is provided.

### SUMMARY

An objective of the present disclosure is to provide a tightening and adjustment device so as to solve the problems in the prior art that tightness adjustment of a rope strap by a knob is hardly controlled.

In order to achieve the above objective, the present disclosure adopts a technical solution as follows:

a tightening and adjustment device, including: a foundation base, a driving part rotatably connected to the foundation base, and a winding part arranged along a rotation axis of the driving part, where a locking part is arranged between one end of the winding part and the foundation base, a one-way engagement part is arranged between the other end of the winding part and the driving part, and when the driving part rotates, the one-way engagement part drives the winding part to rotate around the axis; and an unlocking part arranged on a side of the one-way engagement part, where when the unlocking part pushes the winding part to move towards the locking part, the winding part is released.

To ensure stable and accurate winding of a rope strap, the winding part includes: a main shaft, where a first limiting column and a second limiting column are arranged on the main shaft, and the first limiting column and the second limiting column are provided with mutually perpendicular limiting surfaces; and a wire spool that is arranged on the first limiting column, where a first threading hole is formed in the first limiting column, a corresponding second threading hole is formed in the wire spool, and an end portion of the rope strap penetrates through the threading hole and is fixed on the wire spool.

To prevent the wound rope strap from becoming tangled, further, the foundation base is fixedly connected to a storage bin, the main shaft penetrates through the storage bin, and the wire spool is arranged inside the storage bin, where a threading groove is formed in the storage bin, and the threading groove and the threading hole match each other.

To facilitate control over a winding force, further, the driving part includes a swing base, a first cavity and a second cavity are formed at both ends of the swing base, the locking part is arranged inside the second cavity, and the one-way engagement part is arranged inside in the first cavity, where the swing base is fixedly connected to a shifting plate, which drives the swing base to swing.

Furthermore, a swing angle of the swing base 6 ranges from 5° to 90°.

To ensure reliability of swinging and winding the rope strap, furthermore, the one-way engagement part includes a locking ring connected to the second limiting column, where at least one elastic arm is arranged on a circumferential surface of the locking ring, a first ratchet tooth is arranged at a free end of the elastic arm, a toothed ring is fixedly connected in the first cavity, and the first ratchet tooth engages with the toothed ring.

Further, the number of the elastic arms is set as 3, and the three elastic arms are arranged on a circumferential surface of the locking ring and distributed at an equal interval around a circumference thereof.

To ensure the stability of the rope strap after winding, furthermore, the locking part includes: a ratchet wheel fixedly connected to one end of the main shaft; and a wedge block snap-fitted into the foundation base, where a second ratchet tooth is formed on the wedge block, and the second ratchet tooth engages with the ratchet wheel.

To facilitate adjustment of a winding length of the rope strap, furthermore, the unlocking part includes: a button, where an expansion buckle is fixedly connected to an end portion of the second limiting column, the button is snap-fitted with the expansion buckle, and the button abuts against the locking ring; and a spring is arranged at one end of the main shaft close to the ratchet wheel, an end cover is in snap-in connection with an opening end of the second cavity, and both ends of the spring respectively abut against the ratchet wheel and the end cover.

Further, a guide block and a snapping block are fixedly connected in the second cavity, a guide groove corresponding to the guide block is formed on the end cover, and a snapping groove that is in fit with the snapping block is formed on the end cover.

Compared with the prior art, the present disclosure provides a tightening and adjustment device, and has the following beneficial effects:

for the swing-type tightening and adjustment device, the winding length of the rope strap can be adjusted by rotating the driving part to drive the winding part to rotate unidirectionally, the wound rope strap can be pulled out by just pressing the unlocking part to unlock the winding part, and in a winding process, the driving part that covers the winding part is capable of better transmitting a rotational force to the winding part, such that the winding becomes easier without need of occupying excessive space as a whole; for the tightening and adjustment device, when the main shaft capable of rotating and sliding drives the wire spool to rotate, the rope strap is effectively wound through the wire spool; for the tightening and adjustment device, the wire spool is arranged inside the storage bin, when the rope strap is wound, the storage bin is capable of limiting a capacity of the wound rope strap and preventing it from becoming loose or tangled, a threading groove is formed in the storage bin, the threading groove and the threading hole match each other, and the rope strap penetrates through the threading groove, extends into the threading hole and is tied around the wire spool, such that when wound around the wire spool, the rope strap, through the threading groove, is prevented from becoming tangled during winding or unwinding; for the tightening and adjustment device, by converting a rotational form into a lever swing form, the wire spool can rotate in an easier manner, and less space is occupied, the shifting plate extends above the support plate, and the support plate plays a role of supporting and limiting, which enables to precisely control a winding length during each rotation and achieve three-dimensional features of the entire tightening and adjustment device; and for the tightening and adjustment device, the driving part, through the toothed ring, drives the locking ring to rotate unidirectionally, such that through the main shaft, the wire spool is driven to synchronously rotate to wind the rope strap; when the rope strap needs to be released, the main shaft and the locking ring move synchronously to one side, to complete disengagement of the first ratchet tooth with the toothed ring, such that the main shaft can rotate freely, and in this case, the rope strap can be released from the wire spool in a way of pulling.

The parts of the device not mentioned herein are the same as the prior art or can be implemented by using the prior art. In the present disclosure, back-and-forth swinging of the shifting plate drives the entire swing base to rotate on the foundation base, and further drives the wire spool to rotate unidirectionally for winding, which achieves effortless and space-saving winding length adjustment. Combined with a method of pressing the button for unlocking, a release length of the rope strap can be adjusted in a convenient and quick manner.

### BRIEF DESCRIPTION OF THE DRAWINGS

FIG. 1 is a space diagram of a first view of a tightening and adjustment device provided by the present disclosure.

FIG. 2 is a space diagram of a second view of a tightening and adjustment device provided by the present disclosure.

FIG. 3 is a space diagram of a third view of a tightening and adjustment device provided by the present disclosure.

FIG. 4 is a schematic diagram I of a partial structure of a tightening and adjustment device provided by the present disclosure.

FIG. 5 is a schematic diagram II of a partial structure of a tightening and adjustment device provided by the present disclosure.

FIG. 6 is a schematic diagram III of a partial structure of a tightening and adjustment device provided by the present disclosure.

In the figures: 1. foundation base; 2. support plate; 3. storage bin; 4. threading groove; 5. accommodating groove; 6. swing base; 7. shifting plate; 8. first cavity; 9. toothed ring; 10. second cavity; 11. guide block; 12. snapping block; 13. latch groove; 14. end cover; 15. guide groove; 16. snapping groove; 17. latch block; 18. main shaft; 19. first limiting column; 20. first threading hole; 21. second limiting column; 22. expansion buckle; 23. ratchet wheel; 24. spring; 25. wire spool; 26. second threading hole; 27. wedge block; 28. second ratchet tooth; 29. locking ring; 30. elastic arm; 31. first ratchet tooth; and 32. button.

### DETAILED DESCRIPTIONS OF THE EMBODIMENTS

The technical solutions in the examples of the present disclosure will be clearly and completely described below with reference to the accompanying drawings in the examples of the present disclosure. Obviously, the described examples are merely some examples rather than all examples of the present disclosure.

In the description of the present disclosure, it is to be understood that the terms “upper”, “lower”, “front”, “rear”, “left”, “right”, "top", "bottom", "inner", "outer", etc. indicate azimuthal or positional relations on the basis of those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

### Example

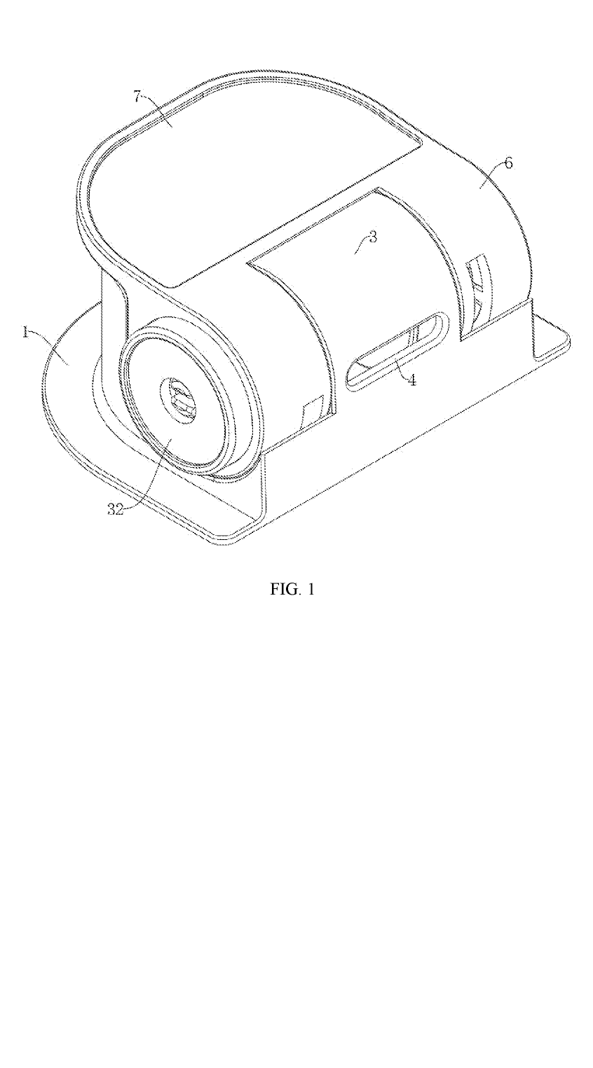

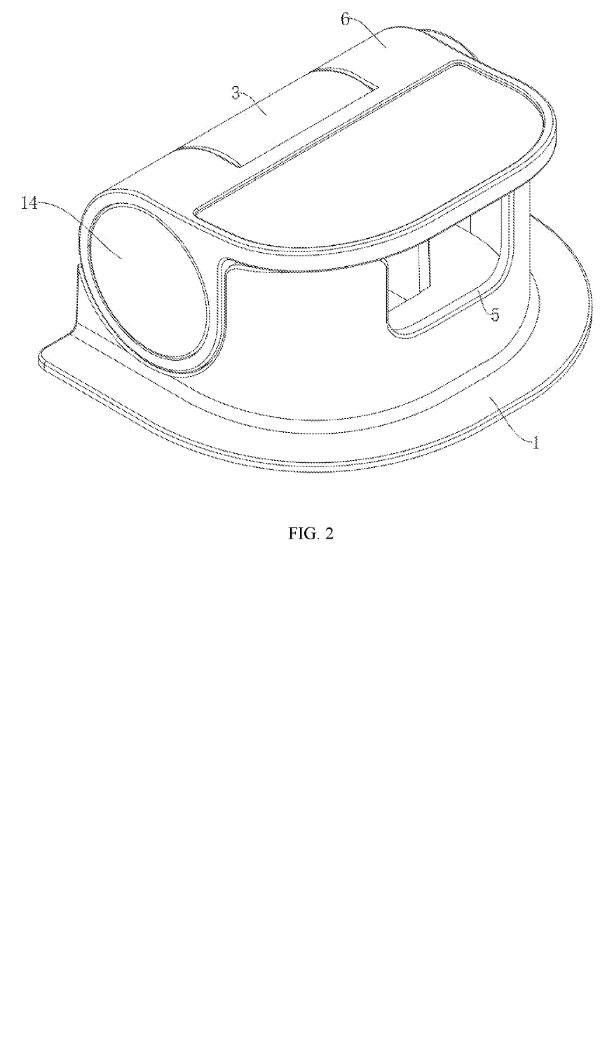

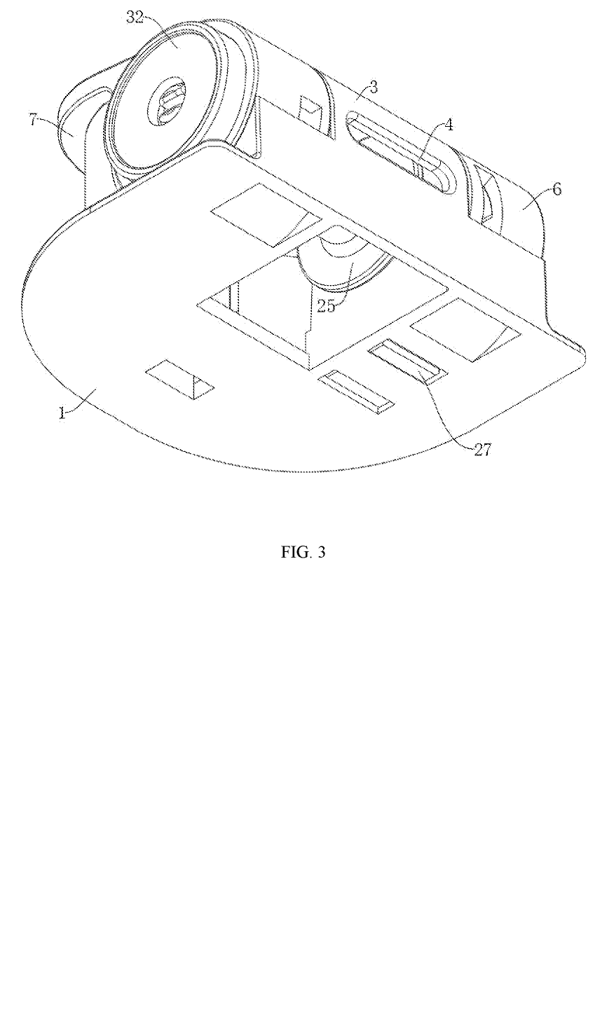

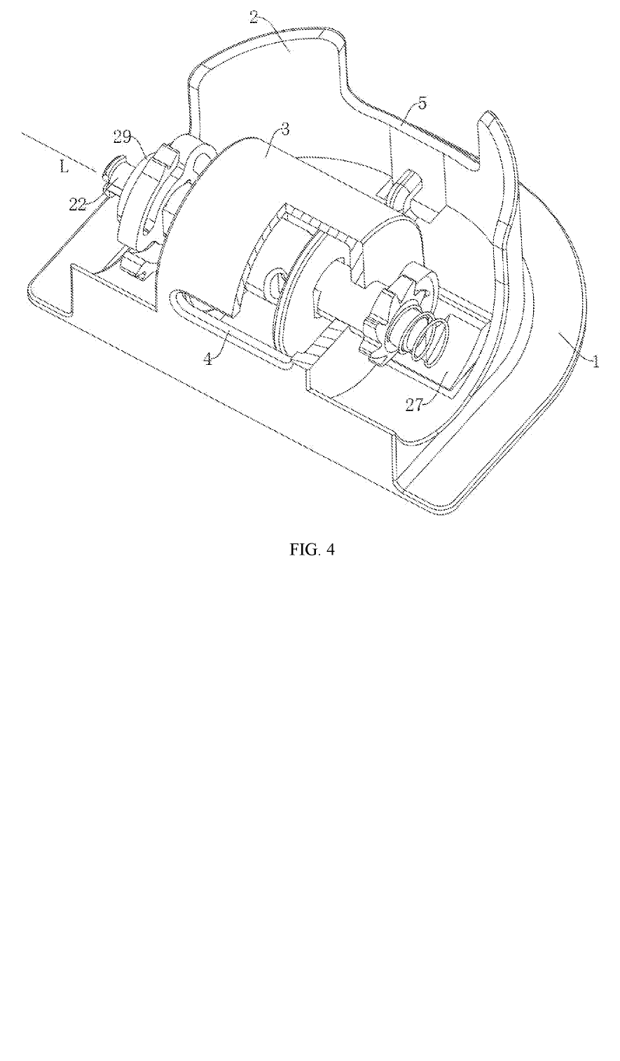

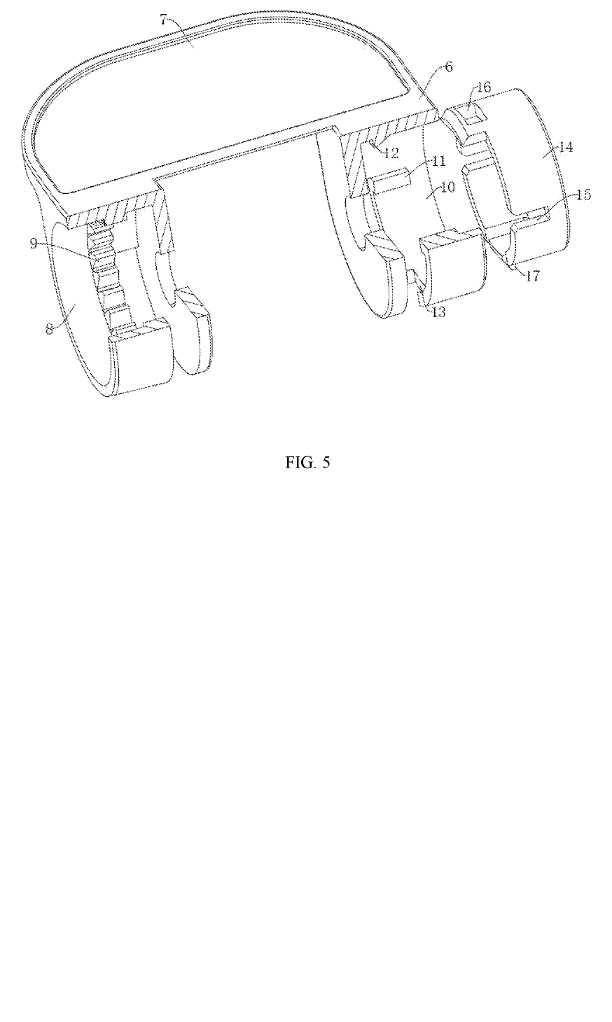

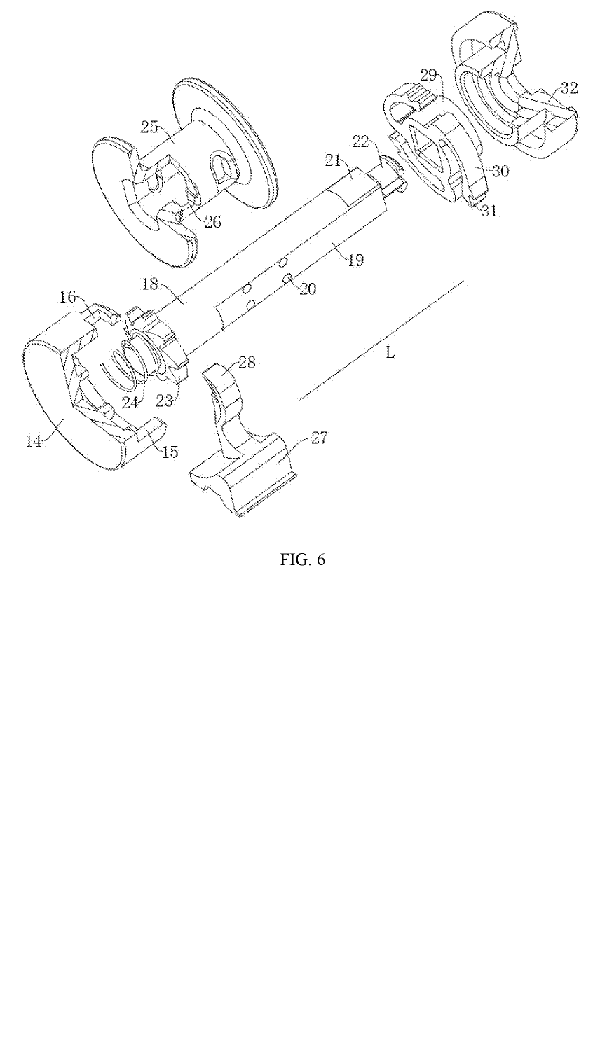

With reference to FIGS. 1-6, a tightening and adjustment device includes: a foundation base 1, where skirt rims are arranged around the foundation base 1 for easy gripping, a support plate 2 is integrally formed at a top thereof to ensure shape stability of the entire tightening and adjustment device, an accommodating groove 5 is formed at a top of the support plate 2 for easy finger insertion and is rotatably connected to a driving part of the foundation base 1, and a winding part is arranged along a rotation axis L of the driving part, where a locking part is arranged between one end of the winding part and the foundation base 1 to prevent loosening or releasing of a wound rope strap, a one-way engagement part is arranged between the other end of the winding part and the driving part, and when the driving part rotates on the foundation base 1, the one-way engagement part drives the winding part to rotate unidirectionally around the axis, so as to complete a tightening action; and an unlocking part is arranged on a side of the one-way engagement part, when the unlocking part pushes the winding part to move towards the locking part, the winding part is released, and in this case, the wound rope strap can be pulled out to adjust a winding length of the rope strap.

In the above scheme, the winding length of the rope strap can be adjusted by rotating the driving part to drive the winding part to rotate unidirectionally, the wound rope strap can be pulled out by just pressing the unlocking part to unlock the winding part, and in a winding process, the driving part that covers the winding part is capable of better transmitting a rotational force to the winding part, such that the winding becomes easier without need of occupying excessive space as a whole.

Specifically, the winding part includes: a main shaft 18 capable of rotating and sliding, where a first limiting column 19 and a second limiting column 21 are formed on the main shaft 18, and the first limiting column 19 and the second limiting column 21 are provided with mutually perpendicular limiting surfaces; and a wire spool 25 that is slidably connected to the first limiting column 19, where a first threading hole 20 is formed in the first limiting column 19, a corresponding second threading hole 26 is formed in the wire spool 25, an end portion of the rope strap penetrates through the threading hole and is fixed on the wire spool 25, and when the main shaft 18 drives the wire spool 25 to rotate, the rope strap is effectively wound through the wire spool 25.

Further, the foundation base 1 is fixedly connected to a storage bin 3, the main shaft 18 penetrates through the storage bin 3 and extends towards both ends thereof, and the wire spool 25 is arranged inside the storage bin 3. When the rope strap is wound, the storage bin 3 is capable of limiting a capacity of the wound rope strap and preventing it from becoming loose or tangled. A threading groove 4 is formed in the storage bin 3, the threading groove 4 and the threading hole match each other, and the rope strap penetrates through the threading groove 4, extends into the threading hole and is tied around the wire spool 25, such that when wound around the wire spool 25, the rope strap, through the threading groove 4, is prevented from becoming tangled during winding or unwinding.

Specifically, the driving part includes a swing base 6, a first cavity 8 and a second cavity 10 are formed at both ends of the swing base 6, the locking part is arranged inside the second cavity 10, and the one-way engagement part is arranged inside in the first cavity 8. The swing base 6 is fixedly connected to a shifting plate 7, and the shifting plate 7 serves as an arm of force that drives the swing base 6 to rotate. By converting a rotational form into a lever swing form, the wire spool 25 can rotate in an easier manner, and less space is occupied. Herein, the shifting plate 7 extends above the support plate 2, and the support plate 2 plays a role of supporting and limiting, which enables to precisely control a winding length during each rotation and achieve three-dimensional features of the entire tightening and adjustment device.

Herein, a swing angle of the swing base 6 ranges from 5° to 90°, and is preferably 30°, 45° or 60° in this example.

Specifically, the one-way engagement part includes a locking ring 29 connected to the second limiting column 21, three elastic arms 30 are arranged on a circumferential surface of the locking ring 29 and distributed at an equal interval around a circumference thereof, and a free end of each of the elastic arms 30 is fixedly connected to a first ratchet tooth 31. A toothed ring 9 is fixedly connected in the first cavity 8, and the first ratchet tooth 31 engages with the toothed ring 9. During use, the driving part, through the toothed ring 9, drives the locking ring 29 to rotate unidirectionally, such that through the main shaft 18, the wire spool 25 is driven to synchronously rotate to wind the rope strap. When the rope strap needs to be released, the main shaft 18 and the locking ring 29 move synchronously to one side, to complete disengagement of the first ratchet tooth 31 with the toothed ring 9, such that the main shaft 18 can rotate freely, and in this case, the rope strap can be released from the wire spool 25 in a way of pulling.

Specifically, to prevent the wire spool 25 from unintentionally feeding the rope strap, the locking part includes: a ratchet wheel 23 fixedly connected to one end of the main shaft 18; and a wedge block 27 snap-fitted into the foundation base 1, where a second ratchet tooth 28 is formed on the wedge block 27, and the second ratchet tooth 28 engages with the ratchet wheel 23, that is, each angle formed after the locking ring 29 drives the main shaft 18 to rotate is locked by the ratchet wheel 23, thereby preventing the main shaft 18 from reversing, such that when the rope strap needs to be released, a user only needs to simply press the unlocking part.

Specifically, the unlocking part includes: a button 32 arranged on a side of the locking ring 29, where an expansion buckle 22 is fixedly connected to an end portion of the second limiting column 21, a central hole is formed at a center of the button 32, the expansion buckle 22 penetrates through the central hole and locks the button 32, an internal stepped structure of the button 32 abuts against the locking ring 29, and the locking ring 29 abuts against the main shaft 18, that is, pressing the button 32 inward drives the locking ring 29 and the main shaft 18 to move for a same distance, thereby facilitating unlocking control; and moreover, a spring 24 is arranged at one end of the main shaft 18 close to the ratchet wheel 23, an end cover 14 is in snap-in connection with an opening end of the second cavity 10, both ends of the spring 24 respectively abut against the ratchet wheel 23 and the end cover 14, and this structure enables rapid resetting after releasing the button 32, thereby facilitating subsequent adjustment and winding of the rope strap.

In the present disclosure, a guide block 11 and a snapping block 12 are fixedly connected in the second cavity 10, a guide groove 15 corresponding to the guide block 11 is formed on the end cover 14, and a snapping groove 16 that is in fit with the snapping block 12 is further formed on the end cover 14, such that the end cover 14 can be detachably connected in the second cavity 10. Alternatively, according to another solution, a latch block 17 extends out of the end cover 14, a latch groove 13 is formed in a wall of the second cavity 10, and the end cover 14 can also be fixed through the engagement of the latch block 17 with the latch groove 13.

In the present disclosure, the end portion of the rope strap is connected to the wire spool 25, and back-and-forth swinging of the shifting plate 7 drives the entire swing base 6 to rotate on the foundation base 1, and further drives the wire spool 25 to rotate unidirectionally for winding, which achieves effortless and space-saving winding length adjustment. Combined with a method of pressing the button 32 for unlocking, a release length of the rope strap can be adjusted in a convenient and quick manner.

The foregoing descriptions are merely preferred specific embodiments of the present disclosure, and are not intended to limit the protection scope of the present disclosure. Any equivalent replacements or changes made by a person skilled in the art according to the technical solution of the present disclosure and the inventive concepts thereof within the technical scope disclosed in the present disclosure shall fall within the protection scope of the present disclosure.

What is claimed is:

1. A tightening and adjustment device, comprising:
a foundation base, a driving part rotatably connected to the foundation base, and a winding part arranged along a rotation axis of the driving part, wherein
a locking part is arranged between one end of the winding part and the foundation base, a one-way engagement part is arranged between the other end of the winding part and the driving part, and when the driving part rotates, the one-way engagement part drives the winding part to rotate around the axis; and
an unlocking part arranged on a side of the one-way engagement part, wherein when the unlocking part pushes the winding part to move towards the locking part, the winding part is released.

2. The tightening and adjustment device according to claim 1, wherein the winding part comprises:
a main shaft, wherein
a first limiting column and a second limiting column are arranged on the main shaft, and the first limiting column and the second limiting column are provided with mutually perpendicular limiting surfaces; and
a wire spool that is arranged on the first limiting column, wherein
a first threading hole is formed in the first limiting column, a corresponding second threading hole is formed in the wire spool, and an end portion of the rope strap penetrates through the threading hole and is fixed on the wire spool.

3. The tightening and adjustment device according to claim 2, wherein the foundation base is fixedly connected to a storage bin, the main shaft penetrates through the storage bin, and the wire spool is arranged inside the storage bin, wherein
a threading groove is formed in the storage bin, and the threading groove and the threading hole match each other.

4. The tightening and adjustment device according to claim 2, wherein the driving part comprises a swing base, a first cavity and a second cavity are formed at both ends of the swing base, the locking part is arranged inside the second cavity, and the one-way engagement part is arranged inside in the first cavity, wherein
the swing base is fixedly connected to a shifting plate, which drives the swing base to swing.

5. The tightening and adjustment device according to claim 4, wherein a swing angle of the swing base ranges from 5° to 90°.

6. The tightening and adjustment device according to claim 4, wherein the one-way engagement part comprises a locking ring connected to the second limiting column, wherein
at least one elastic arm is arranged on a circumferential surface of the locking ring, a first ratchet tooth is arranged at a free end of the elastic arm, a toothed ring is fixedly connected in the first cavity, and the first ratchet tooth engages with the toothed ring.

7. The tightening and adjustment device according to claim 6, wherein the number of the elastic arms is set as 3, and the three elastic arms are arranged on a circumferential surface of the locking ring and distributed at an equal interval around a circumference thereof.

8. The tightening and adjustment device according to claim 4, wherein the locking part comprises:
a ratchet wheel fixedly connected to one end of the main shaft; and
a wedge block snap-fitted into the foundation base, wherein a second ratchet tooth is formed on the wedge block, and the second ratchet tooth engages with the ratchet wheel.

9. The tightening and adjustment device according to claim 8, wherein the unlocking part comprises:
a button, wherein
an expansion buckle is fixedly connected to an end portion of the second limiting column, the button is snap-fitted with the expansion buckle, and the button abuts against the locking ring; and
a spring is arranged at one end of the main shaft close to the ratchet wheel, wherein
an end cover is in snap-in connection with an opening end of the second cavity, and both ends of the spring respectively abut against the ratchet wheel and the end cover.

10. The tightening and adjustment device according to claim 9, wherein a guide block and a snapping block are fixedly connected in the second cavity, a guide groove corresponding to the guide block is formed on the end cover, and a snapping groove that is in fit with the snapping block is formed on the end cover.
